(19) United States
(12) Patent Application Publication
(10) Pub. No.: US 2009/0061138 A1
(43) Pub. Date: Mar. 5, 2009

(54) Peelable, biaxially oriented polyester film

(76) Inventors: Herbert Peiffer, Mainz (DE); Bodo Kuhmann, Runkel (DE)

Correspondence Address: PROPAT, L.L.C., 425-C SOUTH SHARON AMITY ROAD, CHARLOTTE, NC, 28211-2841, US

(21) Appl. No.: 12/200,030

(22) Filed: Aug. 28, 2008

(30) Foreign Application Priority Data
Sep. 3, 2007 (DE) 10 2007 041 705.7

(51) Int. Cl. B32B 33/00; B29C 49/08

(52) U.S. Cl. 428/41.3; 264/210.7

(57) ABSTRACT

The invention relates to a coextruded, peelable, and biaxially oriented polyester film with a base layer (B) and with at least one outer layer (A) applied to this base layer (B). The outer layer (A) is heat-sealable and features good peelability with respect to nonpolar substrates, such as polystyrene and polypropylene. The heat-sealable and peelable outer layer (A) includes a copolymer of ethylene and polar-ethylene. The invention further relates to a process for the production of the film and to packaging formed from the film.

### CROSS-REFERENCE TO RELATED APPLICATIONS

This application claims priority to German Patent Application No. 10 2007 041 705.7 filed Sep. 3, 2007 which is hereby incorporated herein by reference in its entirety.

### FIELD OF THE INVENTION

The invention relates to a coextruded, peelable, and biaxially oriented polyester film with a base layer (B) and with at least one outer layer (A) applied to this base layer (B). The outer layer (A) is heat-sealable and features good peelability with respect to various substrates, in particular to substrates comprised of polystyrene (“PS”) or polypropylene (“PP”), or modified versions of these. To this end, the heat-sealable and peelable outer layer (A) comprises an ethylene-polar-ethylene copolymer. The invention further relates to a process for the production of the film and to the use of the film.

### BACKGROUND OF THE INVENTION

The food-and-drink industry makes wide use of containers, either flexible or else non-flexible (rigid), which have peelable lids. A function of the lids is to protect the contents from mechanical damage and contamination, and also to provide a barrier to ingress of gases, such as oxygen and water vapor. The consumer must moreover find the lids easy to open, and this means that they must be peelable. To achieve these objectives the lids have a layer which is heat-sealable and peelable.

In the prior art, the heat-sealable and peelable layer is generally applied to the polyester film by means known as “off-line methods” (i.e. in an additional process step downstream of film production). This method begins by using a conventional process to produce a “standard polyester film”. The resultant polyester film is then coated “off-line” with a heat-sealable and peelable layer, in a further processing step in a coating system. To improve anchoring to the peel layer, the polyester film is usually coated (primed) with an adhesion-promoter layer, or corona-pretreated, prior to application of the peel layer. The primer process begins by dissolving the heat-sealable and peelable polymer in a solvent, which is mostly organic. The finished solution is then applied to the film by way of a suitable application process (knife coater, screen roll, die). The solvent is evaporated in a downstream drying oven, and the peelable polymer remains as a solid layer on the film.

This type of off-line application of the sealable layer is relatively expensive, for a number of reasons. Firstly, from the point of view of the film producer, the coating of the film has to take place in at least one separate step in a specific apparatus. Secondly, the evaporated solvent has to be re-condensed and reclaimed, in order to minimize pollution of the environment by the exhaust air. Thirdly, high monitoring cost is required to ensure that residual solvent content in the coating is minimized.

There is moreover no cost-effective drying process that can completely remove the solvent from the coating, in particular because the duration of the drying procedure is subject to limits. Solvent traces remaining in the coating can then migrate into the foods, where they can interfere with the flavor or indeed can damage the health of consumers.

Various heat-sealable and peelable polyester films produced off-line are marketed. The polyester films differ in the structure and constitution of the outer layer (A). There are some known films and laminates which seal with respect to substrates such as PS, PP, and PET.

DE-A-101 28 711 describes a coextruded, sealable polyolefin film with an outer layer which comprises at least 70% by weight of a co- or terpolymer which is comprised of olefin and of unsaturated carboxylic acid or its ester or its anhydride. The adhesion of said film with respect to PP, PE, PET, PS, PVC, PC, glass, tin-plated steel, and aluminum is described as good. The disadvantages of a polyolefin film when compared with a PET film are poorer barrier to oxygen, lower heat resistance, and poorer mechanical properties. By way of example, sealing of these films is impossible at the temperatures of 160° C. and above which are conventional in industry.

U.S. Pat. No. 4,333,968 describes a polypropylene film which, after longitudinal orientation, is extrusion-coated with ethylene-vinyl acetate copolymer (EVA) and then oriented transversely. In addition to the abovementioned disadvantages of polyolefin film, another factor here is the low heat resistance of the EVA, making it impossible to regrind and reuse chopped film.

WO 03/033258 describes a sealable and peelable cover-film laminate. The laminate is comprised of three layers, a layer of fibrous material (e.g. paper), a polymeric oxygen-barrier layer (PET, EVOH, and/or polyamide), and a sealable layer. The two last layers are, for example, coextruded, being laminated onto the first layer. The sealable layer is comprised of a combination of ethylene-methyl acrylate copolymer (EMA), EVA, and polyamide wax. The weight per unit area of the sealable layer is from 5 to 30 g/m², and it seals with respect to PE, PP, and PS. The laminate is used as cover in food-and-drink packaging, e.g. for dairy products. The disadvantages of said laminate are not only complicated production but also the optical properties (luster) of the paper surface, which are poorer in comparison with PET film, and poorer printability. The laminate is moreover per se not recycleable.

WO 06/055656 relates to a sealable film or a laminate with a sealable film, where the sealable layer has an antifogging agent. The sealable layer of the film comprises or is comprised of an ethylene copolymer or a modified ethylene copolymer or both. The ethylene copolymer is a copolymer, a terpolymer, or a tetrapolymer, which contains repeat units derived from ethylene, and which contains 5 to 50% by weight of one or more polar monomers selected from the group consisting of vinyl alkanoic acid, acrylic acid, alpha-alkylacrylic acid, alkyl acrylate (=acrylate), and alpha-alkyl acrylate. The percentages by weight are based on the total amount of the ethylene copolymer or of the modified ethylene copolymer in the sealable layer. The sealable layer, the film comprising the sealable layer, and, respectively, the further layers can be manufactured by a plurality of processes not specified in any greater detail, e.g. by way of the production of blown film, in-line or off-line by means of a variety of coating processes, or by means of coextrusion. Further layers mentioned are those produced from nylon, polypropylene, polyethylene, ionomers, polyethylene-vinyl acetate, polyethylene terephthalate, polystyrene, polyethylene-vinyl alcohol, polyvinylidene chloride, or a combination of two or more of these materials.

Laminates (thickness 63.5 μm) are cited in the examples, these being produced via adhesive lamination (not via coextrusion) from two different types of film. The film support used comprises a PET film of thickness 12 μm, and the sealable film used comprises a blown film comprised of three layers. The layers are comprised of HDPE, and HDPE+LDPE, and of modified EVA or EMA in the sealable layer. The laminate features high production costs and cannot moreover be reground, and is therefore not environmentally compatible. The mechanical properties of the film/of the laminate (film curls) and its thermal and optical properties (haze, luster) are moreover unsatisfactory (comprising cloudy HDPE).

EP-A-1 471 096, EP-A-1 471 097, EP-A-1 475 228, EP-A-1 475 229, EP-A-1 471 094, and EP-A-1 471 098 describe heat-sealable polyester films which are peelable with respect to A/CPET and which have ABC structure, and which, in order to establish the desired peel properties in the peelable and heat-sealable outer layer (A), comprise amorphous aromatic and aliphatic copolyesters and either from about 2 to 10% by weight of inorganic or organic particles or else a polymer incompatible with polyester, e.g. norbornene-ethylene. The films feature good peel properties with respect to PET, but not with respect to PS and PP. The films are not sealable with respect to these materials.

### SUMMARY OF ADVANTAGEOUS EMBODIMENTS OF THE INVENTION

It was an object of the present invention to provide a coextruded, heat-sealable and peelable, biaxially oriented polyester film which features excellent peel properties, in particular with respect to substrates comprised of polystyrene (“PS”) or polypropylene (“PP”), or modified versions of these. It is intended to eliminate the disadvantages of the films of the prior art and in particular to feature the following combinations of properties:
It should peel with respect to PS and PP, and this means that the peel force should be greater than or equal to 2.5 N/15 mm, of film strip width preferably greater than or equal to 3.0 N/15 mm, of film strip width and particularly preferably greater than or equal to 3.5 N/15 mm, of film strip width (based on a 60 μm thick film).
The heat-sealable and peelable layer should be heat-sealable with respect to PS and PP, i.e. to have a minimum sealing temperature smaller than or equal to 150° C., preferably smaller than or equal to 140° C., in particular smaller than or equal to 130° C. (based on a 60 μm thick film).
The heat-sealable and peelable layer should not delaminate from the base layer during peeling. To this end, it is desirable (required) that the adhesion of the peel layer (without application of any additional adhesive) with respect to the base layer is greater than the seal seam strength (=peel force).
The film should be capable of economic production. This means by way of example that the film can be produced by stretching processes conventional in industry. The film should moreover be capable of production at machine speeds of up to 500 m/min which are conventional nowadays, and should also be regrindable (recycleable).

Heat-sealable here means that property of a coextruded polyester film comprising at least one outer layer (=heat-sealable outer layer (A)) that allows it to be bonded by means of sealing jaws via application of heat (from 130 to 220° C.) and pressure (from 2 to 5 bar) within a certain time (from 0.2 to 4 s) to itself (fin sealing) or to a substrate comprised of thermoplastic (in particular here PS and PP), while the backing layer (=base layer (B)) does not itself become plastic during this process.

Peelable here means that property of a coextruded polyester film comprising at least one outer layer (=heat-sealable and peelable outer layer (A)) that allows it, after heat-sealing to a substrate (in essence here PS and PP), to be peeled away again from the substrate in such a way that no tearing or break-off of the film occurs during this process. When the film is peeled from the substrate, the composite comprised of heat-sealable film and substrate should part in the seam between the heat-sealable layer and the substrate surface.

### DETAILED DESCRIPTION OF ADVANTAGEOUS EMBODIMENTS OF THE INVENTION

The above noted objects of the invention are achieved via provision of a coextruded, biaxially oriented polyester film, comprising a base layer (B) and a heat-sealable outer layer (A) which is peelable with respect to polystyrene (“PS”) and polypropylene (“PP” and which has been applied via coextrusion to the base layer (B), where
a) the heat-sealable and peelable outer layer (A) is comprised mainly of a composition comprised of from 30 to 95% by weight of ethylene-polar-ethylene copolymer, and
   from 5 to 70% by weight of polyester,
   where the proportion of polar-ethylene in the ethylene-polar-ethylene copolymer is from 12 to 50 mol %,
b) the thickness of the outer layer (A), d_{A}, is from 2.0 to 20 μm, and
c) the outer layer (A) comprises particles whose average diameter is from 2.5 to 15 μm and whose concentration is from 0.5 to 10% by weight (based on the outer layer (A)).

When molar percentages are stated in the polymer or copolymer,—unless otherwise stated—they are based on the units derived from the monomers mentioned in the polymer or copolymer. The same applies to the description of the structure of the polymers and copolymers themselves.

The heat-sealable and peelable outer layer (A) has characteristic features. It has a minimum sealing temperature of not more than 150° C. with respect to polystyrene (“PS”) and polypropylene (“PP”), preferably not more than 140° C., and particularly preferably not more than 130° C., and a seal seam strength of at least 2.5 N with respect to PS and PP, preferably at least 3.0 N, and particularly preferably at least 3.5 N (always based on 15 mm of film width and a film thickness of 60 μm). The maximum sealing temperature of the heat-sealable and peelable outer layer (A) with respect to PS and PP is generally 220° C., and in the entire sealing range (minimum sealing temperature to maximum sealing temperature) a film which is peelable with respect to PS and PP is obtained here.

The film of the present invention comprises a base layer (B) and at least one outer layer (A) of the invention. In this case, the film has a two-layer structure. In one preferred embodiment, the film is comprised of three or more layers. In the case of the particularly preferred three-layer embodiment, it is then comprised of the base layer (B), of the outer layer (A) of the invention, and of an outer layer (C) opposite to the outer layer (A). In the case of a four-layer embodiment, the film comprises an intermediate layer (D) between the base layer (B) and the outer layer (A) or (C).

Base Layer (B)

The base layer of the film is comprised of at least 80% by weight of thermoplastic polyester. Polyesters suitable for this purpose are those comprised of ethylene glycol and terephthalic acid (=polyethylene terephthalate, PET), of ethylene glycol and naphthalene-2,6-dicarboxylic acid (=polyethylene 2,6-naphthalate, PEN), of 1,4-bishydroxymethylcyclohexane and terephthalic acid (=poly-1,4-cyclohexanedimethylene terephthalate, PCDT), and also of ethylene glycol, naphthalene-2,6-dicarboxylic acid, and biphenyl-4,4′-dicarboxylic acid (=polyethylene 2,6-naphthalate bibenzoate, PENBB). Preference is given to polyesters which contain ethylene units and which—based on the dicarboxylate units—are comprised of at least 90 mol %, particularly preferably at least 95 mol %, of terephthalate units or 2,6-napthalate units. The remaining monomer units derive from other dicarboxylic acids and, respectively, diols. For the base layer (B), it is also possible and advantageous to use copolymers or mixtures or blends comprised of the homo- and/or copolymers mentioned. In the data for the amounts of the dicarboxylic acids, the total amount of all of the dicarboxylic acids is 100 mol %. By analogy, the total amount of all of the diols is also 100 mol %.

Preferred suitable other aromatic dicarboxylic acids are benzenedicarboxylic acids, naphthalenedicarboxylic acids (such as naphthalene-1,4- or -1,6-dicarboxylic acid), biphenyl-x,x′-dicarboxylic acids (in particular biphenyl-4,4′-dicarboxylic acid), diphenylacetylene-x,x′-dicarboxylic acids (in particular diphenylacetylene-4,4′-dicarboxylic acid), or stilbene-x,x′-dicarboxylic acids. Among the cycloaliphatic dicarboxylic acids, mention may be made of cyclohexanedicarboxylic acids (in particular cyclohexane-1,4-dicarboxylic acid). Among the aliphatic dicarboxylic acids, the (C₃-C₁₉)-alkanediacids are particularly suitable, where the alkane moiety can be straight-chain or branched.

Examples of suitable other aliphatic diols are diethylene glycol, triethylene glycol, aliphatic glycols of the general formula HO—(CH₂)ₙ—OH, where n is a whole number from 3 to 6 (in particular propane-1,3-diol, butane-1,4-diol, pentane-1,5-diol, and hexane-1,6-diol), or branched aliphatic glycols having up to 6 carbon atoms, or cycloaliphatic diols which have one or more rings and which, if appropriate, contain heteroatoms. Among the cycloaliphatic diols, mention may be made of cyclohexanediols (in particular cyclohexane-1,4-diol). Suitable other aromatic diols correspond by way of example to the formula HO—C₆H₄—X—C₆H₄—OH, where X is —CH₂—, —C(CH₃)₂—, —C(CF₃)₂—, —O—, —S—, or —SO₂—. Bisphenols of the formula HO—C₆H₄—C₆H₄—OH also have good suitability.

It is moreover advantageous that the base layer (B) uses a polyester copolymer based on terephthalate and on small amounts (<3 mol %) of isophthalate, or based on terephthalate and on small amounts (<3 mol %) of naphthalate. In this case, the ease of production of the film and its optical properties are particularly good. The base layer (B) then in essence comprises a polyester copolymer comprised mainly of terephthalic acid and isophthalic acid units and/or terephthalic acid and naphthalene-2,6-dicarboxylic acid units, and of ethylene glycol units. The particularly preferred copolyesters which provide the desired properties of the film are those comprised of terephthalate units and of isophthalate units, and of ethylene glycol units.

The polyesters can be prepared by the transesterification process. This process starts from dicarboxylic esters and diols, which are reacted using the conventional transesterification catalysts, such as the salts of zinc, of calcium, of lithium, of magnesium, and of manganese. The intermediates are then polycondensed in the presence of well-known polycondensation catalysts, such as antimony trioxide, titanium oxides, or esters, or else germanium compounds and aluminum compounds. They can equally well be prepared by the direct esterification process in the presence of polycondensation catalysts. This process starts directly from the dicarboxylic acids and from the diols.

The film of the present invention has a structure of at least two layers. It is then comprised of the base layer (B) and of the sealable and peelable outer layer (A) of the invention applied thereto via coextrusion.

Outer Layer (A)

The sealable and peelable outer layer (A) applied via coextrusion to the base layer (B) is comprised of at least 30% by weight, preferably at least 35% by weight, and particularly preferably at least 40% by weight, of an ethylene-polar-ethylene copolymer. The maximum proportion of the ethylene-polar-ethylene copolymer in the sealable and peelable outer layer (A) is 95% by weight, preferably 90% by weight, and particularly preferably 85% by weight.

If the proportion of the ethylene-polar-ethylene copolymer in the sealable and peelable outer layer (A) is less than 30% by weight, the peelability demanded with respect to PS and PP is lost. If the proportion of the ethylene copolymer in the sealable and peelable outer layer (A) is more than 95% by weight, the adhesion of the outer layer (A) to the base layer (B) is too small. The outer layer (A) delaminates from the base layer (B) during peeling, and this is undesirable.

According to the invention, “polar-ethylene” means a monomer unit which is comprised of an ethylene unit and of one or more polar groups pendant therefrom. The ethylene-polar-ethylene copolymer is then comprised of “pure” units derived from ethylene and of units derived from polar-ethylene and corresponding to the formula

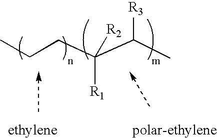

where
R₁ is C₁-C₃-alkoxycarbonyl or
   —CO—OR₄, where
      R₄ is hydrogen, linear or branched C₁-C₁₈-alkyl, which optionally is singularly, doubly, triply, or multiply substituted by OH or by phenyl,
         C₅-C₁₂-cycloalkyl, which, optionally, is bridged by a C₁-C₃ bridge, and/or which has single, double, or multiple substitution by lower alkyl,
         phenyl, or
         —(CH₂—CH₂—O)_{q}—R₅, where
      R₅ is hydrogen, C₁-C₂₄-alkyl, or phenyl, where the phenyl can be singularly, doubly, or multiply substituted by C₁-C₁₂-alkyl, and
R₂ is hydrogen or lower alkyl,
and
R₃ is —COOR₆ or hydrogen, where
   R₆ is hydrogen or a lower alkyl radical, and
n and m are identical or different whole numbers, where the sum n+m corresponds to the degree of polymerization of the ethylene-polar-ethylene copolymer, and
q is the degree of polymerization of the radical —(CH₂—CH₂—O)_{q}—R₅.

Preference is given to copolymers in which
R₁ is methoxycarbonyl or
   —CO—OR₄, where
   R₄ is hydrogen, linear or branched C₁-C₁₈-alkyl, which optionally is singularly substituted by OH or by phenyl or triply substituted by OH,
      C₅-C₆-cycloalkyl, which optionally has bridging by a C₁ bridge and/or is substituted by lower alkyl,
      phenyl, or
      —(CH₂—CH₂—O)_{q}—R₅ where
      R₅ is hydrogen, methyl, C₂₂-alkyl, or phenyl, where the phenyl can be substituted by C₇-C₉-alkyl, and
R₂ is hydrogen or methyl,
and
R₃ is —COOR₆ or hydrogen, where
   R₆ is hydrogen or a lower alkyl radical, and
n and m are identical or different whole numbers, where the sum n+m corresponds to the degree of polymerization of the ethylene-polar-ethylene copolymer, and
q is the degree of polymerization of the radical —(CH₂—CH₂—O)_{q}—R₅.

“Lower-alkyl” means a methyl, ethyl, propyl, isopropyl, butyl, isobutyl, or tert-butyl radical.

The proportion of polar-ethylene-based repeat units in the ethylene-polar-ethylene copolymer is from 12 to 50 mol %, preferably from 14 to 45 mol %, and particularly preferably from 16 to 40 mol %.

Examples of these polar-ethylene monomers include vinyl acetate, acrylic acid, methacrylic acid, ethyl acrylate, ethyl methacrylate, methyl acrylate, methyl methacrylate, propyl acrylate, propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate, n-hexyl acrylate, n-hexyl methacrylate, n-octyl acrylate, n-octyl methacrylate, 2-octyl acrylate, 2-octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, cyclohexyl acrylate, cyclohexyl methacrylate, benzyl acrylate, benzyl methacrylate, phenyl acrylate, phenyl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol)methyl ether acrylate, poly(ethylene glycol)methyl ether methacrylate, poly(ethylene glycol)behenyl ether acrylate, poly(ethylene glycol)behenyl ether methacrylate, poly(ethylene glycol) 4-nonylphenyl ether acrylate, poly(ethylene glycol) 4-nonylphenyl ether methacrylate, poly(ethylene glycol)phenyl ether acrylate, poly(ethylene glycol)phenyl ether methacrylate, dimethyl maleate, diethyl maleate, dibutyl maleate, dimethyl fumarates, diethyl fumarates, and dibutyl fumarates, preference being given here to those which contain vinyl acetate, acrylic acid, methacrylic acid, or alkyl(meth)acrylate, or a combination of two or more thereof.

The ethylene-polar-ethylene copolymers used in the invention are either commercially available per se or can easily be produced via processes familiar to the person skilled in the art, for example via processes as described in WO 06/055656.

According to the invention, the sealable and peelable outer layer (A) comprises an amount of polyester in the range from 5 to 70% by weight, preferably from 10 to 65% by weight, and particularly preferably from 15 to 60% by weight, alongside the ethylene-polar-ethylene copolymer.

If the proportion of the polyester in the sealable and peelable outer layer (A) is less than 5% by weight, the adhesion of the outer layer (A) to the base layer (B) is too low. The outer layer (A) delaminates from the base layer (B) during peeling, and this is undesirable. If the proportion of the polyester in the sealable and peelable outer layer (A) is more than 70% by weight, it becomes impossible to achieve the peel force demanded with respect to PS and PP.

The polyester selected is generally the same as previously described for the base. By way of example, it can be selected from the group of PET, PEIT (polyester copolymer based on terephthalate and isophthalate), and mixtures thereof.

It has proven particularly advantageous here to use a polyester based on copolyesters which are mainly comprised of isophthalic acid units and terephthalic acid units, and of ethylene glycol units. The remaining monomer units are derived from the other aliphatic, cycloaliphatic, or aromatic diols and, respectively, dicarboxylic acids that can also occur in the base layer. The preferred copolyesters which provide the desired sealing properties and the desired peel properties are those comprised of ethylene terephthalate units and of ethylene isophthalate units, and of ethylene diglycol units. The proportion of ethylene terephthalate here is from 60 to 95 mol %, and the corresponding proportion of ethylene isophthalate is from 40 to 5 mol %. Preference is given to copolyesters in which the proportion of ethylene terephthalate is from 65 to 90 mol %, and the corresponding proportion of ethylene isophthalate is from 35 to 10 mol %, and most preference is given to copolyesters in which the proportion of ethylene terephthalate is from 70 to 85 mol %, and the corresponding proportion of ethylene isophthalate is from 30 to 15 mol %.

The outer layer (A) is mainly comprised of the polymers described. “Mainly” means that they are comprised of at least 90% by weight of said polymers. Up to 10% by weight of additives can be present in this layer.

The heat-sealable and peelable outer layer (A) also comprises inorganic and/or organic particles (also termed “pigments” or “antiblocking agents”) at a concentration of from 0.5 to 10% by weight, based on the weight of the outer layer (A). In one preferred embodiment, the outer layer (A) comprises inorganic and/or organic particles at a concentration of from 0.7 to 9% by weight, based on the weight of the outer layer (A). In one particularly preferred embodiment, the outer layer (A) comprises inorganic and/or organic particles at a concentration of from 1.0 to 8% by weight, based on the weight of the outer layer (A).

Usual particles are inorganic and/or organic particles such as calcium carbonate, amorphous silica, talc, magnesium carbonate, barium carbonate, calcium sulfate, barium sulfate, lithium phosphate, calcium phosphate, magnesisum phosphate, aluminum oxide, lithium fluoride, the calcium, barium, zinc, or manganese salts of the dicarboxylic acids used, titanium dioxide, kaolin, or crosslinked polystyrene particles, or crosslinked acrylate particles. The particles can be added to the layer in the respective advantageous concentrations, e.g. in the form of a glycolic dispersion during the polycondensation reaction, or by way of masterbatches during extrusion.

Particles preferred in the invention are synthetically produced, amorphous SiO₂ particles in colloidal form. These particles become exceptionally well bonded into the polymer matrix and produce only few vacuoles (cavities). Vacuoles are produced at the particles during biaxial orientation, and generally cause haze, and are therefore not very suitable for the present invention. Suitable particles can be purchased, for example, from the companies Grace, Fuji, Degussa, or Ineos.

The particles advantageously have a median diameter d₅₀ from 2.0 to 15 μm. In one preferred embodiment, the median diameter d₅₀ of the particles is from 2.5 to 15 μm, and in one particularly preferred embodiment the median diameter d₅₀ of the particles is from 3.0 to 15 μm.

For a further improvement in the processing performance of the film of the present invention, it is advantageous that the ratio of particle diameter and layer thickness is in the range from 0.2 to 2.0, preferably in the range from 0.25 to 1.8, and particularly preferably in the range from 0.3 to 1.5.

It is moreover advantageous likewise to incorporate particles into the base layer (B) in the case of a two-layer film structure (AB), or into the outer layer (C) in the case of a three-layer film structure (ABC).

In the two-layer embodiment, and in the particularly advantageous three-layer embodiment, of the film of the invention, the thickness of the outer layer (A) is in the range from 2 to 20 μm, preferably in the range from 3 to 19 μm, and particularly preferably in the range from 4 to 18 μm. If the thickness of the outer layer (A) is less than 2 μm, however, the film loses its heat-sealability with respect to PS and PP.

The thickness of the other outer layer (C), if present, can be the same as that of the outer layer (A) or different therefrom; its thickness is generally from 1 to 20 μm.

The total thickness of the polyester film of the invention can vary within certain limits. It is from 5 to 500 μm, in particular from 10 to 450 μm, preferably from 15 to 400 μm, and the proportion made up by the layer (B) here is preferably from 45 to 97%, based on the total thickness.

In one preferred embodiment of the film of the present invention, the base layer (B) comprises at least one whitening pigment at a concentration of from 3 to 20%, preferably from 4 to 18%. The concentration here is selected in the invention in such a way that Berger whiteness of the film is greater than 70. Otherwise, the optical properties of the film make it rather unsuitable for the intended applications (e.g. sealed lid film on pots), because the film is too transparent.

In order to achieve the abovementioned properties, in particular the desired whiteness of the film, the necessary pigments are incorporated both into the base layer (B) and into the outer layer (C). Examples of those that can be used are titanium dioxide, calcium carbonate, barium sulfate, zinc sulfide, or zinc oxide. TiO₂ is preferably used as sole colorant pigment. It is preferably added in the form of extruded masterbatch (in which the concentration of titanium dioxide is markedly higher than in the biaxially oriented film) to the original polymer. A typical value for TiO₂ concentration in the extruded masterbatch is 50% by weight of titanium dioxide. The titanium dioxide can be either of rutile type or else of anatase type. It is preferable to use titanium dioxide of rutile type. The grain size of the titanium dioxide is generally from 0.05 to 0.5 μm, preferably from 0.1 to 0.3 μm. The incorporated pigments give the film a brilliant white appearance. In order to achieve the desired whiteness (>70) and the desired low transparency (<50%), the base layer (B) should have a high fill level. The particle concentration for achievement of the desired low transparency is greater than or equal to 3% by weight, but smaller than or equal to 20% by weight, preferably above 4% by weight, but below 18% by weight, based on the total weight of the base layer (B).

For a further increase in whiteness, suitable optical brighteners can be added to the base layer and/or to the other layers. Examples of suitable optical brighteners are HOSTALUX® KS (Clariant, DE) or EASTOBRITE® OB-1 (Eastman, USA).

It has been found that the preferred use of TiO₂ as colorant pigment makes the film less susceptible to tearing and delamination. Addition of the TiO₂, preferably by way of masterbatch technology, has the advantage that color differences, for example those due to inconsistent regrind properties, can be corrected relatively easily. If TiO₂ is used as sole pigment, the film becomes particularly smooth and thus more glossy, but may possibly have a tendency toward blocking.

The base layer and the other layers can also comprise conventional additives, such as stabilizers (UV, hydrolysis), and flame-retardant substances, or fillers. They are advantageously added to the polymer or the polymer mixture before the melting process begins.

The invention also provides a process for the production of the polyester film of the invention by extrusion processes known per se from the literature (“Handbook of Thermoplastic Polyesters, ed. S. Fakirov, Wiley-VCH, 2002” or in the chapter “Polyesters, Films” in “Encyclopedia of Polymer Science and Engineering, vol. 12, John Wiley & Sons, 1988”).

The procedure for the purposes of said process is that the melt corresponding to the film is extruded through a flat-film die, the resultant film is drawn off on one or more rolls for solidification, and the film is then biaxially stretched (oriented), and the biaxially stretched film is heat-set and, if appropriate, also corona- or flame-treated on the surface layer intended for treatment.

The biaxial stretching (orientation) is generally carried out sequentially, and preference is then given here to the sequential biaxial stretching process in which the material is first stretched longitudinally (in machine direction) and then stretched transversely (perpendicularly to the machine direction).

The polymer or the polymer mixture for the film is first, as conventional in the extrusion process, compressed and plasticized in an extruder, and any additives provided as additions here can by this stage be present in the polymer or in the polymer mixture. The melt is then simultaneously forced through a flat-film die, and the extruded melt is drawn off on one or more cooled take-off rolls, whereupon the melt cools and solidifies to give a prefilm.

The biaxial stretching process is generally carried out sequentially. For this, the prefilm is preferably first stretched longitudinally (i.e. in machine direction=MD), and then stretched transversely (i.e. perpendicularly to the machine direction=TD). This leads to spatial orientation of the polymer chains. The longitudinal stretching process can be carried out with the aid of two rolls rotating at different speeds corresponding to the stretching ratio desired. For the transverse stretching process, an appropriate tenter frame is generally used, in which the film is clamped at both edges and is then drawn toward the two sides at elevated temperature.

The temperature at which the stretching process is carried out can vary relatively widely and depends on the desired properties of the film. The longitudinal stretching process is generally carried out at a temperature in the range from 60 to 130° C. (heating temperatures from 60 to 130° C., stretching temperatures from 60 to 130° C.), and the transverse stretching process is generally carried out within the temperature range from 90° C. (start of stretching) to 140° C. (end of stretching). The longitudinal stretching ratio is generally in the range from 2.0:1 to 5:1, preferably from 2.5:1 to 4.5:1. The transverse stretching ratio is generally in the range from 3.0:1 to 5.0:1, preferably from 3.5:1 to 4.5:1.

In the heat-setting process which follows, the film is kept for a period of from about 0.1 to 10 s at a temperature in the range from 150 to 250° C. The film is then wound up in the usual way.

After the biaxial stretching process, the surface opposite of the sealable side of the film can be corona- or flame-treated by one of the known methods. The intensity of treatment is adjusted so as to give a surface tension in the range above 45 mN/m.

The film can also be coated in order to establish other desired properties. Typical properties have adhesion-promoting, antistatic, slip-improving, hydrophilic, or release effect. These additional layers can be applied to the film by way of in-line coating by means of aqueous dispersions after the longitudinal stretching step and prior to the transverse stretching step.

The gloss of the film surface (B) in the case of a two-layer film, or the gloss of the film surface (C) in the case of a three-layer film, is greater than 40 (measured to DIN 67530 by analogy with ASTM D523-78 and ISO 2813 using an angle of incidence of 20°). In one preferred embodiment, the gloss of said sides is more than 50, and in one particularly preferred embodiment it is more than 60. These film surfaces are therefore particularly suitable for a further functional coating, or for printing, or for metallization.

The film of the invention has excellent suitability for the packing of foods and of other consumable items, in particular for the packaging of dairy products in pots, where peelable polyester films are used to open the package.

The table below (table 1) once again provides the most advantageous film properties of the invention:

TABLE 1

| | | | | |
|---|---|---|---|---|
| Range of the | | Particularly | | |
| invention | Preferred | preferred | Unit | Test method |

Outer layer (A)

| | | | | |
|---|---|---|---|---|
| Proportion of ethylene-polar- | from 30 to 95 | from 35 to 90 | from 40 to 85 | % by weight |
| ethylene copolymer | | | | |
| Proportion of polyester | from 5 to 70 | from 10 to 65 | from 15 to 60 | % by weight |
| Proportion of polar-ethylene in | from 12 to 50 | from 14 to 45 | from 16 to 40 | mol % |
| copolymer | | | | |
| Filler concentration | from 0.5 to 10 | from 0.7 to 9 | from 1.0 to 8 | % |
| Particle diameter | from 2.0 to 15 | from 2.5 to 15 | from 3.0 to 15 | μm |
| Particle diameter/layer thickness | from 0.2 to 2 | from 0.25 to 1.8 | from 0.3 to 1.5 | |
| ratio | | | | |
| Thickness of outer layer (A) | from 2.0 to 20 | from 3.0 to 19 | from 4.0 to 18 | μm |

Film properties

| | | | | | |
|---|---|---|---|---|---|
| Thickness of film | from 5 to 500 | from 10 to 450 | from 15 to 400 | μm | |
| Minimum sealing temperature of | 150 | 140 | 130 | ° C. | internal |
| outer layer (A) with respect to PS | | | | | |
| and PP (for a 60 μm film) | | | | | |
| Seal seam strength of outer layer | ≧2.5 | ≧3.0 | ≧3.5 | N/15 mm | internal |
| (A) with respect to PS and PP (for | | | | | |
| a 60 μm film) | | | | | |
| Adhesion between outer layer (A) | >2.5 | >3.0 | >3.5 | N/15 mm | internal |
| and base layer (B) | | | | | |

For the purposes of the present invention, the following test methods were used to characterize the raw materials and the films:

Measurement of Median diameter d₅₀

The median diameter d₅₀ of the antiblocking agent is determined by means of a laser, using laser scanning on a Malvern Mastersizer (an example of other test equipment being the Horiba LA 500 from Sympathec Helos, using the same principle of measurement). For the tests, the specimens are placed with water in a cell, which is then placed in the test equipment. A laser scans the dispersion and the particle size distribution is determined from the signal via comparison with a calibration curve. The test procedure is automatic and also includes mathematical determination of the d₅₀ value. The d₅₀ value here is defined as being determined as follows from the “relative” cumulative particle size distribution curve: the desired d₅₀ is directly given on the abscissa axis by the intersection of the 50% ordinate value (also termed median) with the cumulative curve.

SV Value

The SV value of the polymer is determined via measurement of relative viscosity (ηᵣₑₗ) of a 1% strength solution in dichloroacetic acid in an Ubbelohde viscosimeter at 25° C. The SV value is defined as follows:

SV=(ηᵣₑₗ−1)*1000.

Seal Seam Strength

To determine seal seam strength, a film strip (length 100 mm×width 15 mm) is placed on an appropriate substrate (PS, PP, and PET) and sealed at the set temperature of ≧130° C., using a sealing time at 1.0 s and a sealing pressure of 4 bar (HSG/ET sealing equipment from Brugger, double-sided heated sealing jaws). The sealed strips are pulled apart at an angle of 180°, and the force needed is determined, using a separation speed of 200 mm/min. Seal seam strength is stated in N per 15 mm of film strip (e.g. 3 N/15 mm).

Determination of Minimum Sealing Temperature

Heat-sealed specimens (seal seam 15 mm×100 mm) are produced with the HSG/ET sealing equipment from Brugger, as described above for measurement of seal seam strength, but the film is sealed at various temperatures with the aid of two heated sealing jaws at a sealing pressure of 4 bar, for a sealing time of 1.0 s. 180° seal seam strength is measured as in the determination of seal seam strength. The minimum sealing temperature is the temperature at which a seal seam strength of at least 0.5 N/15 mm is achieved.

Haze

Hölz haze is determined to ASTM D1003-52.

Gloss

Gloss of the film is determined to DIN 67530. The reflectance value is measured, this being a characteristic optical value for a film surface. Based on the standards ASTM D523-78 and ISO 2813, the angle of incidence is set at 20°. A beam of light at the set angle of incidence hits the flat test surface and is reflected and/or scattered thereby. A proportional electrical variable is displayed representing light rays hitting the photoelectric detector. The value measured is dimensionless and must be stated together with the angle of incidence.

Whiteness

Whiteness is determined by the Berger method, the general method being that more than 20 layers of film are mutually superposed. Whiteness is determined with the aid of the ELREPHO® electrical reflectance photometer from Zeiss, Oberkochem (DE), standard illuminant C, 2° standard observer. Whiteness is defined as

WG=RY+3RZ−3RX

WG=whiteness, and RY, RZ, and RX=corresponding reflection factors using the Y, Z, and X color-measurement filter. The whiteness standard used is a barium sulfate pressing (DIN 5033, part 9). A detailed description is given by way of example in Hansl Loos “Farbmessung” [Color measurement], Verlag Beruf und Schule, Itzehoe (1989).

Melt Index

Melt index is measured to DIN 53735.

Adhesion Between layers

Prior to adhesive bonding, the specimen of film (300 mm long×180 mm wide) is placed on a smooth piece of card (200 mm long×180 mm wide; about 400 g/m², bleached, outer laps coated). The overlapping margins of the film are folded back onto the reverse side and secured with adhesive tape.

For adhesive bonding of the film according to the present invention, use is made of a standard polyester film of 12 μm thickness, and a doctor device and doctor bar No. 3 from Erichsen, applying about 1.5 ml of adhesive (Novacote NC 275+CA 12; mixing ratio: 4/1+7 parts of ethyl acetate) to the outer layer A of the film of the present invention. After aerating to remove the solvent, the standard polyester film is laminated on the outer layer (A) of the film of the present invention using a metal roller (width 200 mm, diameter 90 mm, weight 10 kg, to DIN EN 20 535). The lamination parameters are:

| | |
|---|---|
| Amount of adhesive: | 5 +/− 1 g/m² |
| Aeration after application | 4 min +/− 15 s |
| of adhesive: | |
| Doctor thickness (Erichsen): | 3 |
| Doctor speed level: | about 133 mm/s |
| Bond curing time: | 2 h at 70° C. in a circulating |
| | air drying cabinet |

A 25 mm strip cutter is used to take specimens about 100 mm in length. About 50 mm of composite are needed here, and 50 mm of unbonded separate laps for securing/clamping the test specimen. The test specimens are secured to a sheet metal support by means of double-sided adhesive tape, by way of the entire surface of the reverse side of the film of the present invention (base layer B or outer layer C). The sheet with the composite adhesively bonded thereto is clamped into the lower clamping jaw of the tensile test machine. The clamp separation is 100 mm. The unlaminated end of the standard polyester film is clamped into the upper clamping jaw of the tensile test machine (e.g. Instron, Zwick) so that the resultant peel angle is 180°. The average peel force in N/25 mm is given, rounded to one decimal place.

| | | |
|---|---|---|
| Specimen width: | 25 | mm |
| Pretensioning force: | 0.1 | N |
| Test length: | 25 | mm |
| Separation rate until pretensioning | 25 | mm/min |
| force applied: | | |
| Start position: | 5 | mm |
| Test displacement: | 40 | mm |
| Sensitivity: | 0.01 | N |
| Separation rate: | 100 | mm/min |

The peel force test result is equivalent to the minimum adhesion between the layers, since the adhesion between the adhesive and the standard film is markedly greater.

An inventive example is used below for further illustration of the invention.

### INVENTIVE EXAMPLE 1

Chips comprised of polyethylene terephthalate were fed to the extruder for the base layer (B).

Chips comprised of polyethylene terephthalate and particles were likewise fed to the extruder (twin-screw extruder) for the outer layer (C). The raw materials were melted and homogenized in the two respective extruders in accordance with the process conditions listed in the table below.

Alongside this, a mixture comprised of 80% by weight of ethylene-methyl acrylate copolymer (LOTRYL® 24 MA07 from Arkema, DE) and 20% by weight of polyester, inclusive of antiblocking agent, was fed to a twin-screw extruder with vent(s), for the sealable and peelable outer layer (A). The raw material was melted in the twin-screw extruder in accordance with the process conditions stated in the table below.

Coextrusion in a three-layer die was then used to superpose the three melt streams and discharge them over the die lip. The resultant melt film was cooled and then a transparent, three-layer film with ABC structure was produced at a total thickness of 60 μm by way of stepwise longitudinal and transverse orientation and subsequent setting. The thickness of the outer layer (A) was 10 μm, and the thickness of the outer layer (C) was 2 μm.

Outer layer (A)
80% by weight of ethylene-methyl acrylate copolymer (LOTRYL® 24 MA07 from Arkema in Düsseldorf, DE) having a proportion of 24 mol % of methyl acrylate and a melt index (MFI) of 7 g/10 min
20% by weight of masterbatch comprised of 95% by weight of polyester (=copolymer comprised of 78 mol % of ethylene terephthalate and 22 mol % of ethylene isophthalate) with SV value of 850 and 5.0% by weight of SYLYSIA® 430 (synthetic SiO₂, Fuji, Japan), d₅₀=3.4 μm. The glass transition temperature of the polyester was about 75° C.

Base layer (B)
100% by weight of polyethylene terephthalate with SV value of 800

Outer layer (C), a mixture comprised of
85% by weight of polyethylene terephthalate with SV value of 800
15% by weight of masterbatch comprised of 99% by weight of polyethylene terephthalate (SV value of 800) and 1.0% by weight of SYLOBLOC® 44 H (synthetic SiO₂, Grace, Worms, DE), d₅₀=2.5 μm

The production conditions in the individual steps of the process were:

| | | | | |
|---|---|---|---|---|
| Extrusion | Temperatures | Layer A: | 280° | C. |
| | | Layer B: | 280° | C. |
| | | Layer C: | 280° | C. |
| | Take-off roll | | 25° | C. |
| | temperature | | | |
| Longitudinal | Heating temperature | | 70-110° | C. |
| stretching | | | | |
| | Stretching temperature | | 105° | C. |
| | Longitudinal stretching | | 3.3 | |
| | ratio | | | |
| Transverse | Heating temperature | | 105° | C. |
| stretching | | | | |
| | Stretching temperature | | 135° | C. |
| | Transverse stretching | | 4.0 | |
| | ratio | | | |
| Setting | Temperature | | 230° | C. |
| | Duration | | 3 | s |

The minimum sealing temperatures and the seal seam strengths measured for the film with respect to PS and PP have been entered in table 2. For the test of seal seam strength, the film was sealed at 180° C. with respect to PS and PP (sealing pressure 4 bar, sealing time 1.0 s). Strips of the composite comprised of film of the invention and substrate were then pulled apart in accordance with the abovementioned test specification. In each case, the films were found to peel as desired from the substrate.

TABLE 2

| | PS | PP | Unit |
|---|---|---|---|
| Minimum sealing temperatures | 100 | 102 | ° C. |
| Seal seam strength | 7.8 | 6.5 | N/15 mm |

### COMPARATIVE EXAMPLE 1

Example 1 of EP-A-1 475 228 was repeated. The film exhibited a peelable seal with respect to PET, but not with respect to PS and PP. The film did not seal with respect to these materials.

That which is claimed:

1. A multilayer, coextruded, biaxially oriented, sealable, polyester film comprising a base layer (B) and a heat-sealable outer layer (A) peelable with respect to polystyrene (PS) and polypropylene (PP), wherein
a) the heat-sealable and peelable outer layer (A) is comprised mainly of a composition comprising
from 30 to 95% by weight of ethylene-polar-ethylene copolymer, and
from 5 to 70% by weight of polyester,
where the proportion of polar-ethylene in the ethylene-polar-ethylene copolymer is from 12 to 50 mol %,
b) the thickness of the outer layer (A), d_{A}, is from 2.0 to 20 μm, and
c) the outer layer (A) comprises particles whose average diameter is from 2.5 to 15 μm and whose concentration is from 0.5 to 10% by weight, based on the outer layer (A).

2. The polyester film as claimed in claim 1, wherein the base layer (B) comprises a thermoplastic polyester.

3. The polyester film as claimed in claim 2, wherein the polyester of the base layer (B) contains at least 90 mol % of ethylene glycol units and terephthalic acid units or ethylene glycol units and naphthalene-2,6-dicarboxylic acid units.

4. The polyester film as claimed in claim 2, wherein the polyester of the base layer (B) comprises polyethylene terephthalate.

5. The polyester film as claimed in claim 1, wherein, in the sealable outer layer (A), the proportion of ethylene-polar-ethylene copolymer is from 35 to 90% by weight, and the proportion of polyester is from 10 to 65% by weight.

6. The polyester film as claimed in claim 1, wherein the sealable outer layer (A) further comprises SiO₂ particles as pigment.

7. The polyester film as claimed in claim 1, wherein the thickness of the sealable outer layer (A) is from 2.0 to 20 μm.

8. The polyester film as claimed in claim 1, wherein the minimum sealing temperature of the sealable outer layer (A) with respect to PS and PP is 150° C. or lower.

9. A process for producing a coextruded polyester film as claimed in claim 1, comprising the steps of
a) producing a multilayer film by coextrusion,
b) biaxially stretching the coextruded film, and
c) heat-setting the biaxially stretched film,
wherein the polyester film comprises a base layer and at least one heat-sealable and peelable outer layer (A), and the heat-sealable and peelable outer layer (A) is comprised mainly of a composition comprising from 30 to 95% by weight of ethylene-polar-ethylene copolymer and from 5 to 70% by weight of polyester, and the proportion of polar-ethylene in the ethylene-polar-ethylene copolymer is from 12 to 50 mol %, and the outer layer (A) further comprises particles whose average diameter is from 2.5 to 15 μm, said particles present at a concentration of from 0.5 to 10% by weight, based on the outer layer (A).

10. Food or other consumable item packaging comprising a film as claimed in claim 1.

11. Food or other consumable item packaging as claimed in claim 10, wherein the food packaging is packaging for dairy products in pots.
